(19) United States
(12) Patent Application Publication
(10) Pub. No.: US 2004/0247458 A1
(43) Pub. Date: Dec. 9, 2004

(54) Fluid machine

(76) Inventors: Shigeki Iwanami, Okazaki-city (JP); Kazuhide Uchida, Hamamatsu-city (JP)

Correspondence Address: POSZ & BETHARDS, PLC, 11250 ROGER BACON DRIVE, SUITE 10, RESTON, VA, 20190, US

(21) Appl. No.: 10/852,188

(22) Filed: May 25, 2004

(30) Foreign Application Priority Data
Jun. 5, 2003 (JP) 2003-160951

(51) Int. Cl. F04B 49/00

(52) U.S. Cl. 417/316; 417/410.5

(57) ABSTRACT

The invention relates to a fluid machine, more particularly to a hybrid compressor for a motor vehicle and has an object to reduce vibration and noises thereof.

According to a feature of the present invention, a fluid machine comprises a pump mechanism (compressor) for compressing fluid by receiving a driving force at least from an outside driving source (engine) or an electric motor, wherein when the pump mechanism is driven by the outside driving source (engine), a torque in an opposite phase to a component of torque variation generated at the pump mechanism is applied by the electric motor to the pump mechanism. And thereby the component of the torque variation at the pump mechanism can be set off by the torque in the opposite phase generated at the electric motor to reduce the vibration and noises at the pump mechanism and/or accessories, such as an alternators mounted to the engine.

### CROSS REFERENCE TO RELATED APPLICATION

This application is based on Japanese Patent Application No. 2003-160951 filed on Jun. 5, 2003, the disclosures of which is incorporated herein by reference.

### FIELD OF THE INVENTION

The present invention relates to a fluid machine having a pump mechanism (compressor) for compressing working fluid (refrigerant) and driven by at least an outside driving source or an electric motor, in particular to a fluid machine to be used for a hybrid vehicle which runs by a combination of driving forces from an electric motor and an internal combustion engine.

### BACKGROUND OF THE INVENTION

In a conventional stationary air-conditioner, for example an air-conditioner for home use, a compressor is driven by an electric motor. The electric motor is operated at least two different control modes, one of which is an operational control mode when a rotational speed of the electric motor is low and the other of which is an operational control mode when the rotational speed of the electric motor is high, so that vibration of the compressor is decreased in a low speed operation thereof.

The hybrid vehicle already in the market has an electric motor and an internal combustion engine for running the vehicle, wherein the vehicle runs by a driving force from the electric motor alone, by a driving force from the engine alone, or by a combination of those driving forces. A compressor of an air-conditioner for the hybrid vehicle is, accordingly, driven by a driving force from the engine or driven by an electric motor provided for exclusively driving the compressor.

Since the compressor sucks and compresses the working fluid (refrigerant), anti-torque at the compressor varies so that the anti-torque at a suction stroke is smaller than that at a compression stroke.

When the compressor is driven by the driving force from the engine via a power transmitting means, such as V-belts, the variation of the anti-torque generated at the compressor will be transmitted to the engine through the V-belts. As a result, accessories mounted to the engine, such as an alternator, may be resonated to generate a larger vibration and noise, i.e. resonance of accessories.

### SUMMARY OF THE INVENTION

It is, therefore, an object of the present invention, in view of the above mentioned problems, to provide a new fluid machine which is capable to suppress vibration and noises thereof.

According to a feature of the present invention, a fluid machine comprises a pump mechanism (compressor) for compressing a working fluid by receiving a driving force at least from an outside driving source (engine) or an electric motor, wherein when the pump mechanism is driven by the outside source of driving force (engine), a torque in an opposite phase to a component of torque variation generated at the pump mechanism is applied by the electric motor to the pump mechanism. And thereby the component of the torque variation at the pump mechanism can be set off by the torque in the opposite phase generated at the electric motor to reduce the vibration and noises at the pump mechanism and/or accessories, such as an alternator, mounted to the engine.

According to another feature of the present invention, the electric motor, the pump mechanism (compressor) and a power transmitting device for transmitting the driving force from the outside driving source (engine) to the pump mechanism are integrally assembled as a one unit.

According to a further feature of the present invention, when the pump mechanism (compressor) is driven by the outside driving source (engine) and when a frequency of the vibration of the pump mechanism reaches a predetermined frequency range (for resonance frequency range), the supply of the electric power to an electromagnetic clutch (the power transmitting device) is cut off and the operation of the pump mechanism will be continued by the driving force from the electric motor.

As a result, the vibration of the pump mechanism is prevented from being transmitted to the outside driving source, and thereby the resonance of accessories can be prevented.

According to a further feature of the present invention, when the pump mechanism (compressor) is driven by the outside driving source (engine) and when a rotational speed of the pump mechanism reaches a predetermined speed range (for resonance speed range), the supply of the electric power to the electromagnetic clutch (the power transmitting device) is cut off and the operation of the pump mechanism will be continued by the driving force from the electric motor.

As a result, the same effect can be obtained, namely the vibration of the pump mechanism is prevented from being transmitted to the outside driving source, and thereby the resonance of accessories can be prevented.

According to a further feature of the present invention, the electric motor, the power transmitting device (the electromagnetic clutch) and the pump mechanism (compressor) are operatively connected with each other by a single rotating shaft.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a control system for vehicle accessories according to the present invention;

FIG. 2 is a cross-sectional view showing an electrically driven compressor according to a first embodiment of the present invention;

FIG. 3 is a graph showing a relationship between a torque and a rotational angle of a shaft;

FIG. 4 is a graph showing a relationship between maximum displacement of vibrations for an alternator and a rotational speed of a shaft;

FIG. 5 is a cross-sectional view showing an electrically driven compressor according to a second embodiment of the present invention;

FIG. 6 is a graph showing an operation of a power transmitting device for the second embodiment; and

FIG. 7 is a graph showing a relationship between a torque and a rotational angle of a shaft.

### DETAILED DESCRIPTION OF THE PREFERRED EMBODIMENTS

(First Embodiment)

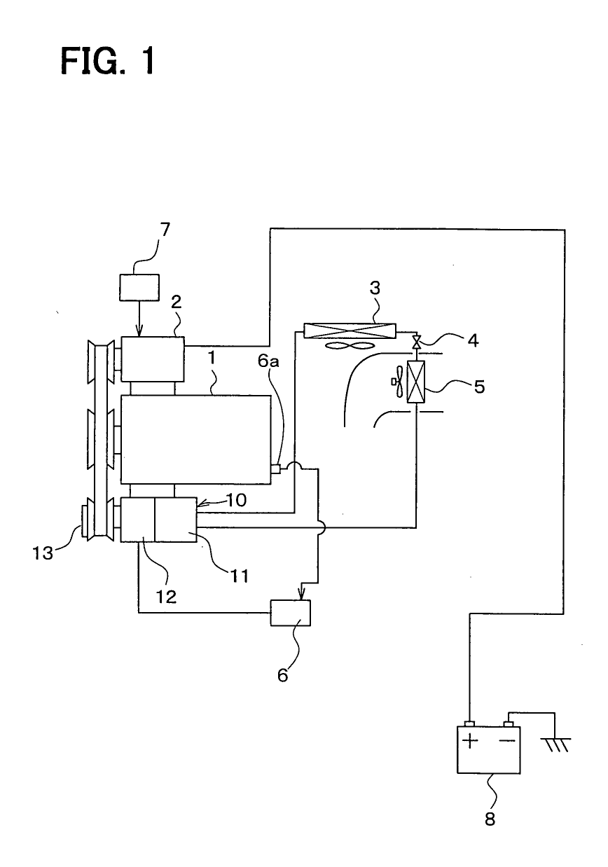

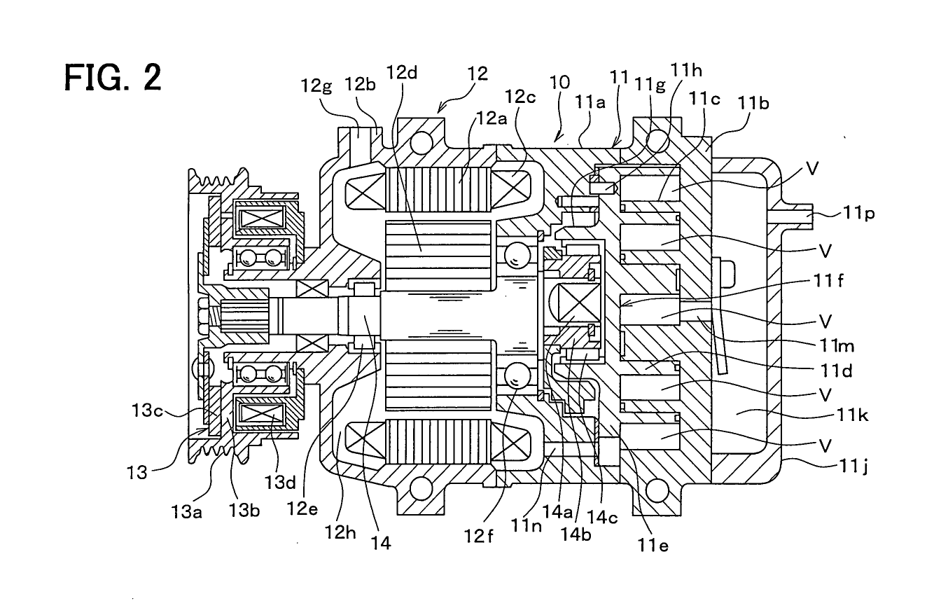

A first embodiment of the present invention will now be explained with reference to FIGS. 1 and 2, wherein FIG. 1 shows a schematic diagram of a control system for vehicle accessories, and FIG. 2 shows a cross-sectional view of an electrically driven compressor according to a first embodiment of the present invention

In FIG. 1, a numeral 1 designates an internal combustion engine (an outside driving source) generating a driving force for vehicle running, a numeral 2 designates an alternator (an engine accessory) driven by the driving force from the engine to generate electric power which will be charged into a battery 8.

In the alternator 2, as is well known, a field current to be supplied to a rotor is controlled by a voltage regulator 7 to control strength of rotating magnetic field, and thereby to control electric power to be generated.

A numeral 11 designates a compressor which is driven by at least one of the driving force from the engine 1 and a driving force of an electric rotating machine (electric motor) 12, wherein the compressor 11 sucks and compresses working fluid (refrigerant of a refrigerating cycle). In the present embodiment shown in FIG. 2, a numeral 10 designates a hybrid compressor (fluid machine), which is of an all-in-one unit comprising the compressor 11 and the electric motor 12 integrally and operatively connected to the compressor 11.

A numeral 3 designates a condenser, which is a heat exchanger for radiating heat from high-pressure high-temperature refrigerant pumped out from the compressor 11. A numeral 4 designates a pressure reducing device (generally called as an expansion valve) for reducing pressure of the refrigerant cooled down by the condenser 3. A numeral 5 designates an evaporator for evaporating the refrigerant to perform a refrigeration performance. In this embodiment, the condenser 3 cools down the refrigerant through heat exchange with the ambient air, whereas the evaporator 5 heats the refrigerant through heat exchange with air to be blown out into a passenger compartment of the vehicle.

A numeral 6 designates a motor control unit for controlling an operation of the electric motor 12 and a signal of an engine rotational speed is input to the motor control unit 6 from a rotational speed sensor 6a.

When the compressor 11 is driven by the electric motor 12, the rotational speed thereof is controlled by the motor control unit 6 by controlling voltage to be applied to the electric motor. And when the electric motor 12 is operated as the electric power generator, the power generation is controlled by the voltage regulator 7.

The hybrid compressor 10 will be explained with reference to FIG. 2.

The hybrid compressor 10 comprises a scroll type compressor 11 for sucking in and compressing the refrigerant, the electric rotating machine 12 (in this embodiment, DC blushless motor) for driving the compressor 11, and a power transmitting device 13, such as an electromagnetic clutch, for selectively transmitting the driving force from the engine 1 to the compressor 11, wherein the compressor 11,. the electric motor 12 and the electromagnetic clutch 13 are integrally and operatively connected to each other.

As explained above, the electric rotating machine (electric motor) 12 is the DC blushless motor in this embodiment, wherein a stator core 12a is made of magnetic material such as silicon steel plates and fixed to a motor housing 12b by shrink fit or tight fit. A coil 12c is wound on the stator core 12a. The stator core 12a and the coil 12c constitute a stator.

A numeral 12d designates a rotor having multiple permanent magnets and a shaft 14, which is rotationally supported by bearings 12e and 12f.

The bearing 12f is fixed to a middle housing 11a which is fixed to the motor housing 12b by fixing means such as bolts, while the bearing 12e is fixed to the motor housing 12b.

The scroll type compressor 11 is explained. A shell 11b is an element fixed to the middle housing 11a to form a space therein and formed with a spiral scroll wrap 11c extending towards the middle housing 11a. The shell 11b operates as a fixed scroll.

A movable scroll 11f is operatively disposed in the space between the middle housing 11a and the shell (fixed scroll) 11b and comprises a base plate 11e and a spiral scroll wrap 11d protruding from the base plate 11e towards the fixed scroll 11b, wherein wall portions of the spiral scroll wraps 11c and lid are contacted with each other to form working chambers V. When the movable scroll 11f is rotated, the space of the working chamber V will be expanded or decreased to thereby suck in the working fluid (refrigerant) and compress the refrigerant.

A cylindrical boss portion 11g is formed at an almost center of the base plate 11e and a bush 14b is rotationally supported by the cylindrical boss portion 11g via a needle bearing 14c. The bush 14b is connected to a crank portion 14a formed at one end (right-hand end in the drawing) of the shaft 14.

The crank portion 14a is eccentrically formed to the shaft 14 from a rotational center of the shaft 14. And therefore, when the shaft 14 is rotated the movable scroll 11f is rotated with an orbit motion around the shaft 14.

The bush 14b is connected to the crank portion 14a in such a way that the bush 14b will be displaced by a certain small distance in a plain perpendicular to the axis of the shaft 14, so that the movable scroll 11f will be displaced in a direction that contact pressure between the scroll wraps 11c and 11d will be increased by means of a reaction force for compression.

A reference numeral 11h designates an autorotation preventing mechanism (comprising a pair of pins and a ring) for preventing the autorotation of the movable scroll 11f around the crank portion 14a.

When the shaft 14 is rotated, the movable scroll 11f is rotated with the orbital motion around its orbital axis (which is equal to the rotational center of the shaft 14) in a plain perpendicular to the rotational axis of the shaft 14, while the autorotation of the movable scroll 11f around the crank portion 14a is prevented.

A rear housing 11j is fixed to the shell 11b by bolts or the like to form a discharge chamber 11k for equalizing the pressure of the refrigerant by smoothing pulsation of the pumped out refrigerant.

A numeral 11m designates a discharge port formed at almost center of the shell (the fixed scroll) 11b to communicate the working chamber V with the discharge chamber 11k.

A discharge valve and a valve stopper are fixed to the fixed scroll 11b by a bolt at the discharge port, wherein the valve is a check valve of a reed valve type for preventing the pumped out refrigerant from flowing back to the working chamber V from the discharge chamber 11k, and the stopper is a plate for limiting the movement of the reed valve.

When the electric motor 12 is operated, the refrigerant is sucked into the compressor 11 through a suction port 11n. Then refrigerant further flows into a motor chamber 12h having the rotor 12d and the stator through an inlet port 12g formed at the motor housing 12b, to thereby cool down the electric motor 12. The refrigerant compressed by the compressor 11 is discharged through the chamber 11k and an outlet port lip to the condenser 3.

The electromagnetic clutch 13 comprises a pulley 13a rotationally supported by the motor housing 12b and receiving a driving force from the engine via V-belts, an armature plate 13c fixed to the shaft 14, and an electromagnetic coil 13d, so that when the coil 13d is energized the armature plate 13c is attracted to a rotor portion 13b of the pulley 13a to rotate the shaft 14.

As above, the electric motor 12, the electromagnetic clutch 13 and the compressor 11 are operatively connected to each other by the shaft 14 which transmits the driving force.

An operation of the hybrid compressor 10 will now be explained.

[An Operation in Which the Compressor 11 is Driven by the Electric Motor 12]

In this operation, the supply of the electric power to the electromagnetic clutch 13 is cut off to disconnect the compressor 11 from the engine 1 and instead the electric power will be supplied to the coil 12c (the stator). The torque to be generated at the electric motor 12 is controlled by the voltage applied to the electric motor and the rotational speed thereof is controlled by the frequency of the electric current supplied to the coil 12c.

[An Operation in Which the Compressor 11 is Driven by the Engine 1]

In this operation, the electric power is supplied to the electromagnetic clutch 13 to operatively connect the compressor 10 with the engine 1, so that the rotational driving force will be transmitted from the engine 1 to the compressor 11.

In this operation, as shown by a solid line in FIG. 3, a torque (anti-torque) necessary for driving the compressor varies in conjunction with the suction and compression of the refrigerant by the compressor 11. The tension at the V-belts is likewise varied in response to the variation of the torque, and then the variation of the torque is transmitted to the engine 1 via the V-belts. As a result, accessories mounted to the engine 1, such as an alternator, may be resonated to generate a larger vibration and noise, i.e. resonance of accessories.

According to the embodiment of the present invention, a torque in opposite phase (as indicated by a dotted line in FIG. 3) to the torque for driving the compressor 11 is generated by the electric motor 12 and applied to the compressor 11, to set off the torque variation generated at the compressor, and as a result the resonance of accessories can be suppressed.

The torque variation generated at the scroll compressor 11 is determined by geometric configuration thereof, and the frequency of the torque variation is in proportion to the rotational speed of the shaft 14. Accordingly, the frequency of the torque in the opposite phase is determined by calculating the frequency of the torque variation generated at the scroll compressor 11 based on the calculated rotational speed of the shaft 14, namely the compressor 11, from the signal of the rotational speed sensor 6a.

(Second Embodiment)

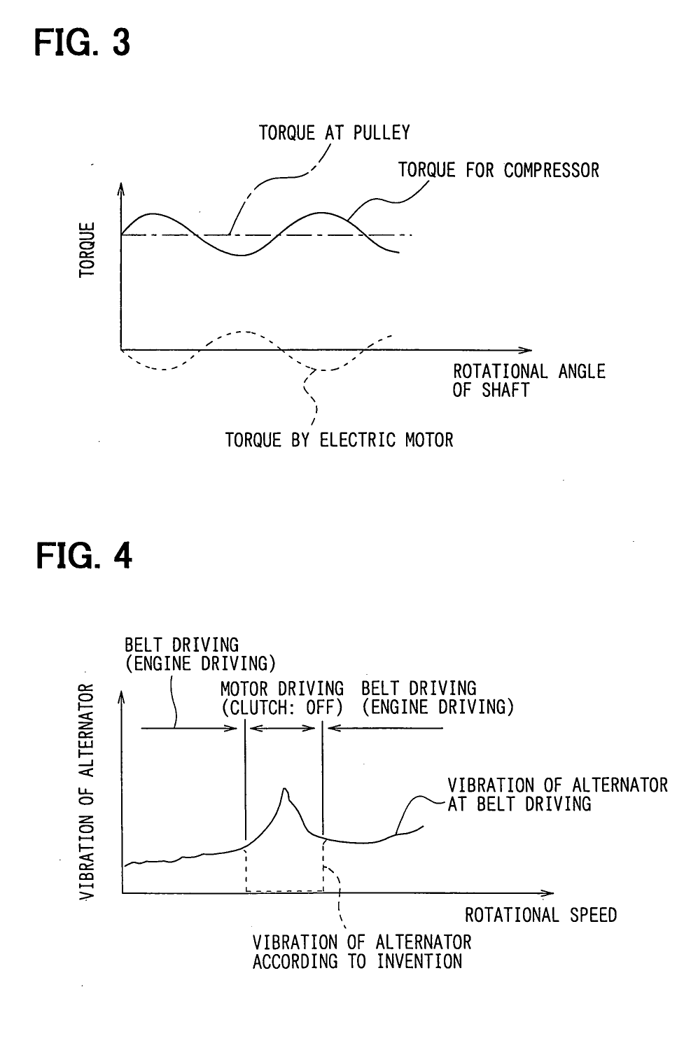

When the mounting rigidity of the accessories, such as the alternator 2, to the engine 1 is low, and the torque variation generated at the compressor 11 corresponds to the resonance frequency of the accessories 2, the resonance of accessories becomes larger, as shown in FIG. 4.

According to the second embodiment, in the case that the compressor 11 is driven by the engine 1, the torque in the opposite phase is likewise generated by the electric motor 12 and applied to the compressor 11, as in the same manner in the first embodiment. In addition, when the frequency of the torque variation generated at the compressor 11 comes closer to the resonance frequency of the accessories, the supply of the electric power to the electromagnetic clutch 13 is cut off to disconnect the compressor 11 from the engine 1 and the compressor is driven by the electric motor 12. As a result of the operation, the resonance of accessories can be surely suppressed.

As explained above, since the frequency of the torque variation generated at the compressor 11 varies in proportion to the rotational speed of the compressor 11, it is determined that the frequency of the torque variation at the compressor 11 reaches an area of the resonance frequency when the rotational speed of the compressor 11 becomes within a predetermined speed range, which is decided in advance according to tests and so on.

When the frequency of the torque variation generated at the compressor 11 goes out of the area of the resonance frequency, the electric power will be again supplied to the electromagnetic clutch 13 to transmit the driving force from the engine 1 to the compressor 11, while the torque in the opposite phase is generated at the electric motor 12 and applied to the compressor 11.

(Third Embodiment)

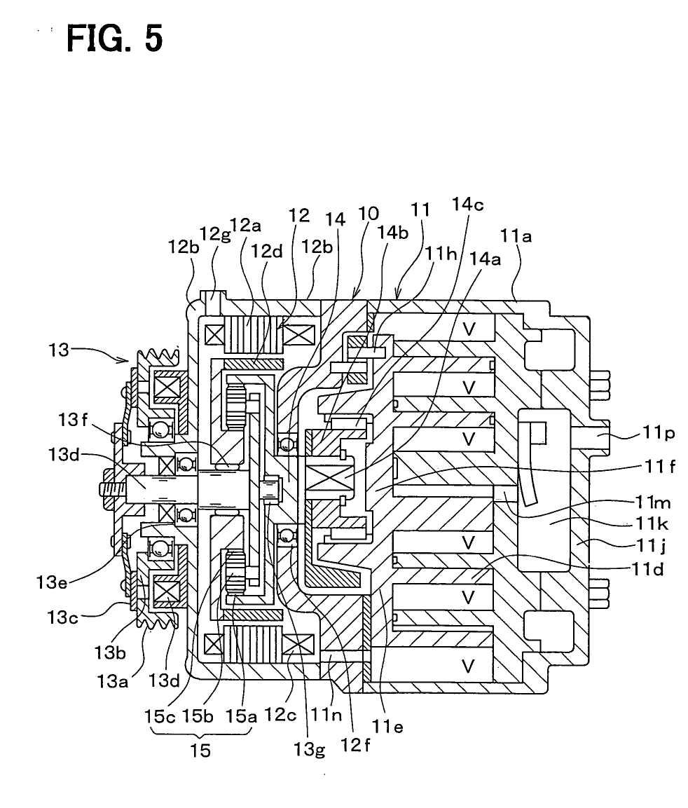

In this embodiment, a variable speed gearing 15 is used for the hybrid compressor 10, as shown in FIG. 5. The variable speed gearing 15 comprises an internal gear (ring gear) 15a of a ring form, multiple (for example, three) planetary gears 15b engaged with the internal gear 15a and a sun gear 15c engaged with the planetary gears 15b.

The sun gear 15c is integrally formed with the rotor 12d of the electric motor 12, the planetary gears 15b are integrally formed to the shaft 13d which rotates with the armature plate 13c of the electromagnetic clutch 13 as one unit, and the ring gear 15a is integrally formed with the shaft 14.

A bearing 13e rotationally supports the shaft 13d, a bearing 13f rotationally supports the sun gear 15c, namely the rotor 12d, with respect to the shaft 14, and a bearing 13g rotationally supports the ring gear 15a with respect to the shaft 14.

An operation of the hybrid compressor 10 according to the third embodiment will be explained.

[An Operation in Which the Compressor 11 is Driven by the Electric Motor 12]

The electric power is supplied to the electromagnetic clutch 13 to connect the shaft 13d with the pulley 13a and the electric power is also supplied to the stator coil 12c.

In this case, a planetary carrier supporting the planetary gear 15b is connected to the pulley 13a via the shaft 13d. As the engine is not running in this case, and thereby the planetary carrier as well as the shaft 13d is not rotated, the rotational force of the electric motor 12 will be transmitted to the scroll compressor 11 via the variable speed gearing 15 with the rotational speed being decreased.

[An Operation in Which the Compressor 11 is Driven by the Engine 1]

The electric power is supplied to the electromagnetic clutch 13 and also to the electric motor 12 to generate such a torque at the rotor 12d that the sun gear, namely the rotor 12d, may not be rotated. As a result, the rotational driving force of the engine 1 transmitted to the electromagnetic clutch 13 will be finally transmitted to the scroll compressor 11 via the variable speed gearing 15 with the rotational speed being increased.

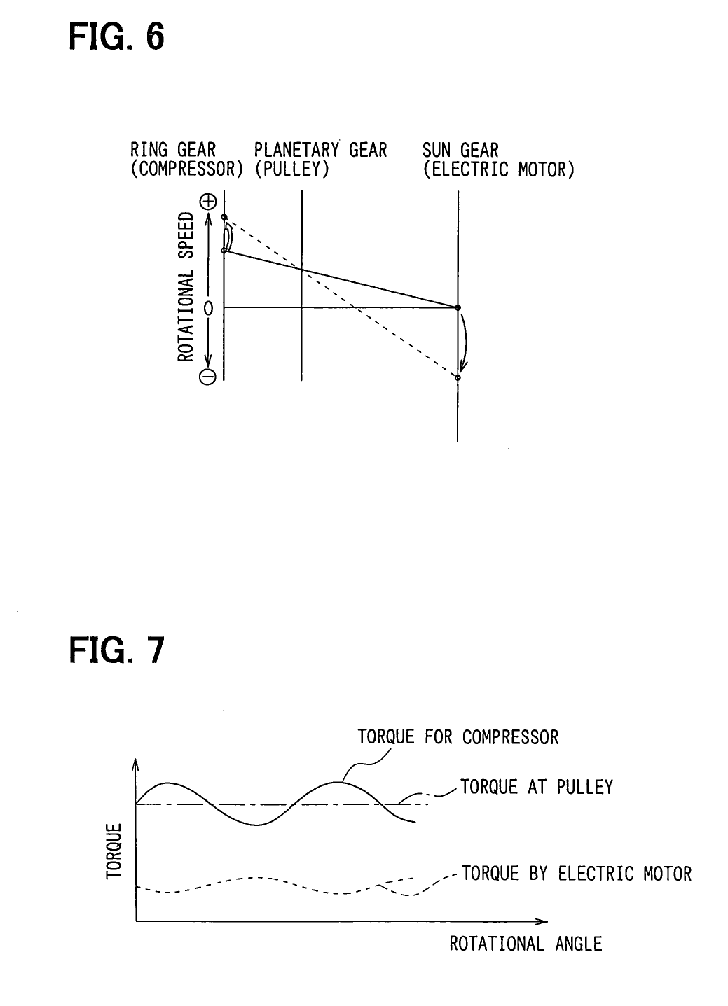

When the sung gear 15c is rotated and the rotational speed is controlled, a change gear ratio can be controlled as shown in FIG. 6. In FIG. 7, a dotted line shows the torque of the electric motor when the change gear ratio is controlled.

(Other Embodiments)

In the above embodiments, although the scroll compressor is used as the pumping machine for compressing the refrigerant, it is not limited to this type, but the other types of the compressors, such as rotary type, piston type, vane type and so on can be used.

Although the above embodiments are explained as the fluid machine to be used to the hybrid compressor for a motor vehicle, however, the present invention can be used for any other fluid machines.

The DC brushless motor is explained as the electric motor 12 in the above embodiments. It is, of course, possible to use any other types of the electric motors can be used for the purpose of the present invention.

In the above embodiments, the electric motor 12, the electromagnetic clutch 13 and the scroll compressor 11 are operatively connected with each other by the shaft 14 which transmits the driving force to the compressor 11. It is, however, not necessary to limit the present invention to this structure.

What is claimed is:

1. A fluid machine comprising:
a pump mechanism operatively connected to an outside driving source for compressing a working fluid; and
an electric motor operatively connected to the pump mechanism;
wherein the pump mechanism is driven by at least one of driving forces from the outside driving source and the electric motor, and
wherein when the pump mechanism is driven by the outside driving source, a torque in an opposite phase to a component of torque variation generated at the pump mechanism is applied by the electric motor to the pump mechanism.

2. A fluid machine according to claim 1 further comprising:
a power transmitting device selectively transmitting the driving force from the outside driving source to the pump mechanism, wherein
the electric motor, the power transmitting device and the pump mechanism are integrally connected to each other as a single one unit.

3. A fluid machine comprising:
a pump mechanism operatively connected to an outside driving source for compressing a working fluid;
an electric motor operatively connected to the pump mechanism; and
a power transmitting device selectively transmitting the driving force from the outside driving source to the pump mechanism,
wherein the pump mechanism is driven by at least one of driving forces from the outside driving source and the electric motor, and
wherein when the pump mechanism is driven by the outside driving source, and when a frequency of the vibration generated at the pump mechanism reaches a predetermined frequency range, the transmission of the driving force from the outside driving source is cut off and the pump mechanism is operated by the electric motor.

4. A fluid machine comprising:
a pump mechanism operatively connected to an outside driving source for compressing a working fluid;
an electric motor operatively connected to the pump mechanism; and
a power transmitting device selectively transmitting the driving force from the outside driving source to the pump mechanism,
wherein the pump mechanism is driven by at least one of driving forces from the outside driving source and the electric motor, and
wherein when the pump mechanism is driven by the outside driving source, and when a rotational speed of the pump mechanism reaches a predetermined speed range, the transmission of the driving force from the outside driving source is cut off and the pump mechanism is operated by the electric motor.

5. A fluid machine according to one of claims 3 and 4,
wherein when the pump mechanism is driven by the outside driving source, a torque in an opposite phase to a component of torque variation generated at the pump mechanism is applied by the electric motor to the pump mechanism.

6. A fluid machine according to one of claims 3 and 4, wherein
the electric motor, the power transmitting device and the pump mechanism are operatively connected with each other by a single rotating shaft.
